(19) United States
(12) Patent Application Publication
(10) Pub. No.: US 2013/0191173 A1
(43) Pub. Date: Jul. 25, 2013

(54) Mobile Ordering

(71) Applicant: Go Swiftly LLC, Farmington, MN (US)

(72) Inventor: Olaleye Shobola, Farmington, MN (US)

(73) Assignee: Go Swiftly LLC, Farmington, MN (US)

(21) Appl. No.: 13/748,113

(22) Filed: Jan. 23, 2013

Related U.S. Application Data
(60) Provisional application No. 61/589,627, filed on Jan. 23, 2012.

(51) Int. Cl. G06Q 20/32; G06Q 50/12

(52) U.S. Cl. CPC G06Q 20/322; G06Q 50/12
USPC 705/5; 705/15; 705/14.64

(57) ABSTRACT

Methods, systems, and computer-readable media with executable instructions stored thereon for mobile ordering. An order for a selected merchant selection can be received. A unique identifier can be associated, by a computing device, to the order. Per a request from the selected merchant, the order associated with the unique identifier can be retrieved. The order can be finalized after the order has been completed.

### CLAIM OF PRIORITY

This application claims the benefit of priority under 35 U.S.C. §119(e) of Shobola, U.S. Provisional Patent Application Ser. No. 61/589,627, entitled “MOBILE ORDERING”, filed on Jan. 23, 2012, which is herein incorporated by reference in its entirety.

### BACKGROUND

A customer's dining experience may vary according to a number of factors. Typically, a restaurant and/or bar attempts to control the number of factors that affect a customer's dining experience to provide the customer with a pleasant dining experience.

### BRIEF DESCRIPTION OF THE DRAWINGS

FIG. 1 is a flow chart illustrating an example of a method for mobile ordering according to the present disclosure.

FIG. 2 is a flow chart illustrating an example of a system for mobile ordering according to the present disclosure.

FIG. 3 illustrates a block diagram of an example of a computer-readable medium in communication with processing resources for mobile ordering according to the present disclosure.

### DETAILED DESCRIPTION

Examples of the present disclosure include methods, systems, and computer-readable media with executable instructions stored thereon for mobile ordering. An order for a selected merchant can be received. A unique identifier can be associated, by a computing device, to the order. Per a request from the selected merchant, the order associated with the unique identifier can be provided. The order can be finalized after the order has been completed.

A typical dining experience, for example, can involve a customer visiting a merchant (e.g., a restaurant and/or a bar) to eat and/or drink. Upon arriving at the merchant, the customer may wait to be seated. After being seated, a merchant representative (e.g., waiter) may then approach the customer and take an order of the customer. The waiter may, for example, enter the order into a point of sale system (POS). The customer may then wait for the order to be prepared and provided to where the customer is seated.

The customer may, for example, signal the waiter to request the bill for the order. The customer may wait for the waiter to generate the bill and return a copy of the printed bill to the customer. The customer may, for example, choose a payment method (e.g., cash, debit, credit, gift card, etc.) and wait for the waiter to return with change and/or a signature request.

Examples of the present disclosure can include a method to reduce, for example, the amount of wait time experienced by a customer during a typical dining experience. For example, the customer may wait less to be seated, to order, to be provided the order, to request the bill, and/or pay for the bill, as compared to previous dining experiences. Benefits of such examples can include, but are not limited to, increasing the overall dining experience of a customer (e.g., increasing a level of satisfaction with a merchant's service), increasing the turn-over rate of customers at a merchant (e.g., decreasing the amount of time a customer stays at a merchant), increasing the potential number of customers a merchant can handle over a given period of time, and/or reducing a number of merchant representatives on staff at a merchant, etc.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

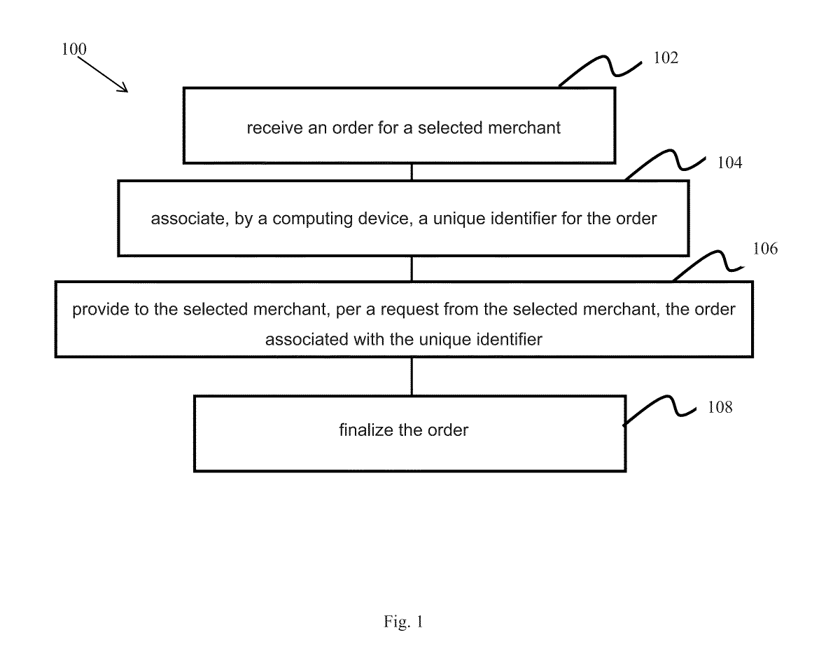

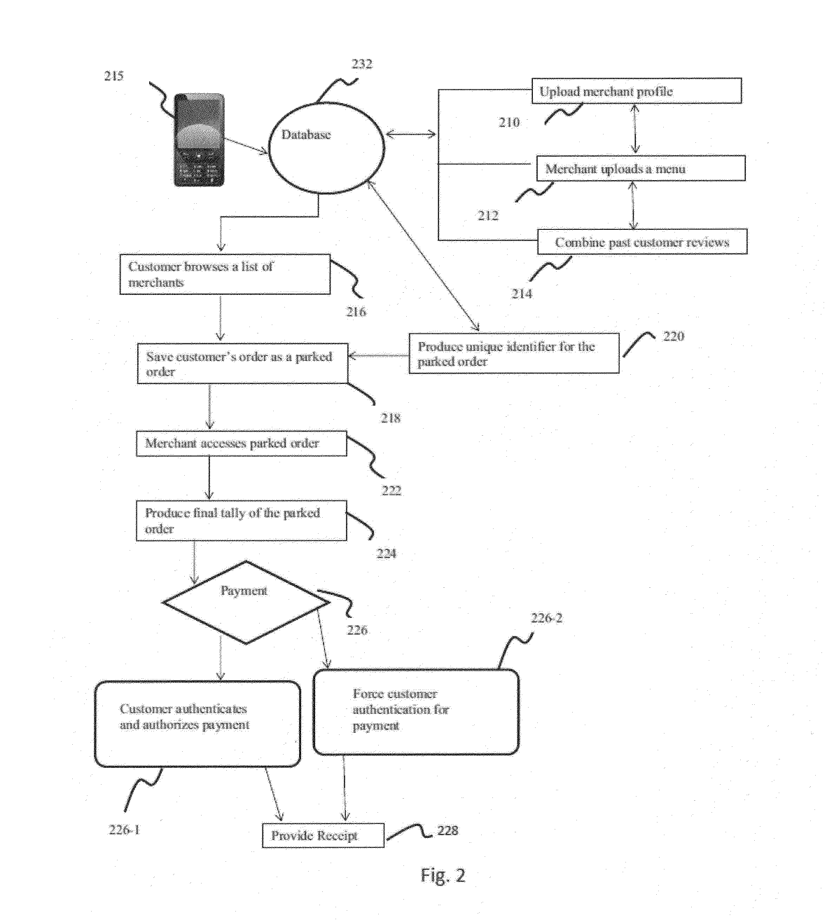

FIG. 1 is a flow chart illustrating an example of a method 100 for mobile ordering, according to the present disclosure. At 102, an order for a selected merchant is received. An order can include, for example, a list of items from an inventory of a merchant. An inventory may include a menu which lists a number of items the merchant can provide. In an example, the merchant is a restaurant and the items are food and/or drinks As will be discussed herein with respect to FIG. 2, the order may, for example, be submitted to a server (e.g., database) from a mobile device, and the server can be accessible by the merchant.

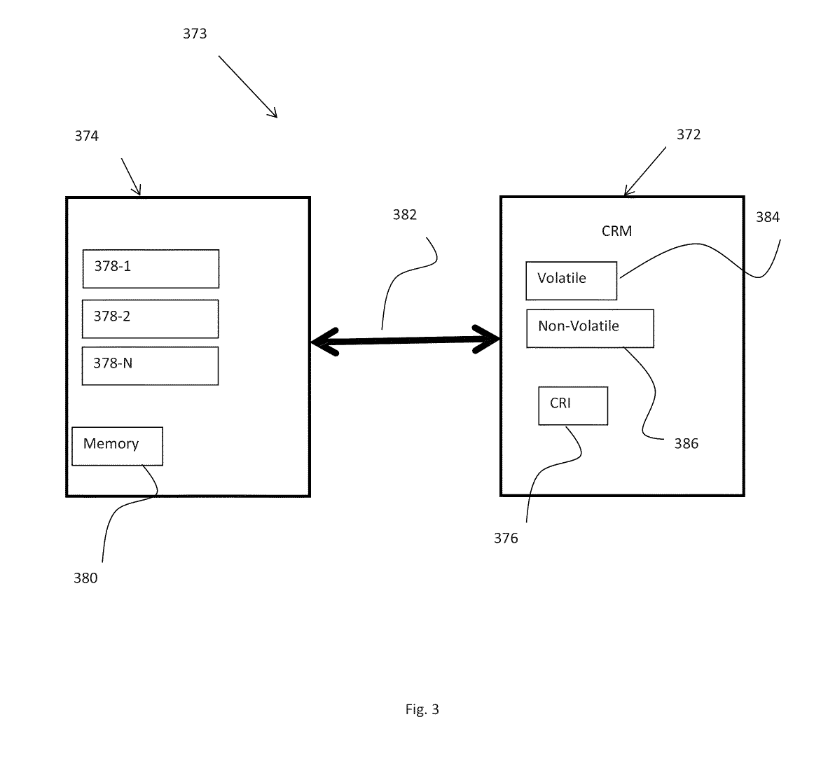

A unique identifier for the order is associated with the order, by a computing device, at 104. A unique identifier can include, but is not limited to, a group of numbers and/or letters, a barcode, and/or a quick reference barcode, etc. The term unique is used to indicate that the identifier is specific to an order. That is, one identifier exists for one order. The computing device may include a computing device as discussed herein with respect to FIG. 3.

The order associated with the unique identifier is provided to the selected merchant, per a request from the selected merchant, at 106. In an example, the request can result from the selected merchant providing the unique identifier. For example, a merchant representative (e.g., waiter) may enter the unique identifier into a mobile ordering system and the system may provide the order associated with that unique identifier to the merchant representative, as discussed herein with respect to FIG. 2.

The order is finalized at 108. Finalizing an order can include, for example, authorizing payment to the merchant for fulfilling the order, storing information pertaining to the order, and providing a merchant survey to the customer. Fulfilling an order can include providing a customer each item on the order associated with the unique identification. The items can, for example, be provided to a customer sitting at a table of the merchant. The customer may, for example, be identified at the table by a display. The display may include the unique identification number, a table number, and/or a way of associating a customer, order or seating location. Location of the customer may, for example, be ascertained by a Global Positions System (GPS) and/or other location device, as discussed herein.

A merchant survey can include a number of questions regarding the dining experience and/or mobile ordering system experience realized by a customer. Responses received regarding the dining experience can be used to produce a ranking of the selected merchant, rate specific items offered by the merchant, rate service experience, or any other customer dining experience criteria.

Responses received regarding the mobile ordering system experience can, for example, be used to improve the mobile ordering system, tailor the mobile ordering system to the customer, and/or tailor the mobile ordering system to the selected merchant. For example, the responses received may indicate that the customer prefers not to go back to the selected merchant after an unpleasant dining experience with the selected merchant. In such an example, the selected merchant can be removed from appearing in a list of merchants for the customer's browsing. The method 100 may include tailoring specific advertisements to the customer based on the received responses.

FIG. 2 is a flow chart illustrating an example of a system for mobile ordering according to the present disclosure. A merchant loads a merchant profile to database 232, at 210. A profile can include merchant information such as, for example, a merchant name, a merchant location, directions to the merchant, and/or a merchant history, etc. In an example, the merchant information can be modified by the merchant. At 212, the merchant uploads a menu. In an example, the merchant can upload photos, additional pricing information, and/or additional information the merchant wants to provide the customer.

The merchant can, for example, load information regarding advertisements and/or discounts. For example, the merchant may decide to advertise to potential customers via the system for mobile ordering. Advertisements may include, but are not limited to, banners displayed to a potential customer and/or paying a fee to have the merchant displayed more prominently than other merchants. Discounts may include, for example, a frequent dining program via the system for mobile ordering, coupons, and/or an incentive program. For example, an incentive program may include some marketing scheme specifically designed to bring in new customers and/or entice customers to return. Discounts may, in an example, be generated via a system for mobile ordering and/or provided by a merchant. Further examples include promotions or promotional items, as discussed herein.

In an example, an incentive program can include discounts to a customer for using the system for mobile ordering. For example, a discount may be provided to the customer if the customer orders via the system for mobile ordering over a threshold number of times, conducts a number of merchant searches via the system for mobile ordering, spends over a threshold amount of money on the system for mobile ordering, invites a designated number of additional customers to provide customer profile information to the system for mobile ordering, and/or combinations thereof, etc.

At 214, the system for mobile ordering can combine past customer reviews with the merchant profile. Reviews can be internal to the system for mobile ordering and/or external to the system for mobile ordering (e.g., publicly available reviews). For example, reviews can include responses received from a merchant survey, as discussed herein. Reviews can include a ranking associated with the merchant, wherein the ranking is provided by the merchant survey as discussed herein. In an example, the ranking associated with the merchant can be provided to a customer, upon request of the customer. A request can include a request to view a list or merchants and/or a request to view a ranking associated with a merchant.

Reviews can relate to the dining experience at the merchant, menu items of the merchant, type of merchant, and/or additional customer considerations. Dining experience can include factors such as, but not limited to, quality of food, quality of service, ambiance of the merchant, overall impression of dining at the merchant, wait time, and/or variety of food, etc. A type of merchant can include a general classification of the merchant's environment. For example, a type of merchant can include, but is not limited to, formality (e.g., casual, business, romantic, etc.), price (e.g., budget, average, expensive), and/or food (e.g., American, Chinese, Italian, steakhouse, sushi, etc.), etc.

Reviews can be combined with the merchant profile on a rolling basis. That is, reviews can continually be combined with the merchant profile so that an up-to-date representation of customer ranking is provided.

Database 232 can include a computer-readable medium and/or a computing device as described herein in connection with FIG. 3. Database 232 can include a merchant profile as discussed herein and/or a customer profile. A customer profile can include, for example, a customer username, a customer password, customer demographic information, customer behavioral information, a constraint provided by the customer, payment information, and/or a customer provided backup unique identifier, etc.

Customer behavioral information can include, for example, a previous order of the customer. In an example, the previous order can be provided to the customer upon request of the customer. Benefits of such examples can include, a list of previous orders the customer can select for ease of use. For example, a customer can select a list of orders to be designated as favorite order that can be recalled and provided to the customer for the customer to select from. Further, previous order information of the customer can, for example, be used to aid in providing a list of merchants to the customer.

In an example, a customer provided backup unique identifier can be stored by database 232. A backup unique identifier can include, for example, an alpha-numeric sequence, password, pin code, customer profile information, etc. The backup unique identifier can be unique to the customer. In an example, the backup unique identifier can be used to retrieve the order when the backup unique identifier is received. For example, when a customer loses the unique identifier associated with the order, the customer may provide the backup unique identifier to retrieve the order. A customer may lose the unique identifier by, for example, losing, breaking, and/or having a dead battery of the mobile device after placing the order but before providing the unique identifier.

At 215, a customer logs in to the system for mobile ordering. For example, the customer can provide a username and/or password via a mobile device. A mobile device may include, for example, a device capable of communicating with the database 232. For example, a laptop may be considered a mobile device, even if the communication connection is a wired Ethernet connection. Examples of mobile devices include, but are not limited to, a mobile phone, a laptop, a computing device, and/or a tablet, etc. In another example, the mobile device used by the customer may have a device identification number that can be used to associate the customer with customer profile information. The mobile device may, in an example, be located outside the merchant. For example, the customer may be at her dwelling and log-in to the system of mobile ordering via the mobile device. In another example, the mobile device can be inside the merchant's establishment. For example, the mobile device can belong to the merchant or to the customer. The mobile device, if owned by the merchant, can be, for example, at a table, at an entrance area of the merchant, in a mobile ordering specific area of the restaurant, and/or combinations thereof.

The customer can browse a list of merchants, at 216. In an example, the list of merchants can be displayed on the mobile device the customer logged in with at 215. The list of merchants can, for example, the list of merchants displayed can be according to a constraint of a customer. For example, a constraint of a customer can include, but is not limited to, proximity of a merchant to the mobile device, a ranking of the merchant, a favorites list of the customer, merchants that have incentive programs currently running, and/or merchant profile information, etc.

In an example, a list of merchants can be provided, wherein each merchant exceeds a threshold stored ranking For example, a customer constraint can provide that merchants above the threshold stored ranking of 80% approval should be provided in the list of merchants. That is, the threshold stored ranking is a floor at which a merchant's ranking should not be below. The customer can then, for example, select a merchant from the list of merchants.

In an example, the list of merchants can be displayed according to the customer constraint that each merchant of the list of merchants is within a predetermined proximity of a mobile device. For example, the customer can log in to the system for mobile ordering at geo-location A. The customer may have a constraint that the list of merchants should include merchants within 25 miles of geo-location A. The geo-location of the customer can be determined via a Global Positioning System (GPS), triangulation, a location entered by the customer, and/or combinations thereof, etc. That is, the term predetermined proximity designates that the proximity is set prior to when the list is searched by the customer. In an example, the merchant can be mobile, such as a food truck. A mobile merchant can have its current location updated on the system for mobile ordering, such as automatically or manually. The mobile merchant can be geo-located, as described herein.

In an example, the mobile device used by the customer to log-in to the system for mobile ordering is owned by the merchant. In such an example, the displayed list of merchants may, include the merchant that owns the mobile device, a list of locations of the merchant that owns the mobile device, and/or combinations thereof.

At 218, the customer's order is saved in database 232 as a parked order. An order can include an order as described herein. For example, an order can be saved when a customer browses a menu of a merchant and makes a selection of items in the menu. In an example, the menu can include, but is not limited to, items for purchase, items for leasing, prices, item rankings, health information, and/or combinations thereof. In an example, the menu can include at least one promotion or promotional item, so as to incentivize a customer's selection. The promotion or promotional item can, for example, be designated by the merchant or programmed.

In an example, merchant designated promotions or promotional items can include, but are not limited to, reduction of a percentage of a cost for an order, reduction in price of the promotional item, reduction in price of additional items, or combinations thereof, etc. The promotion or promotional item can, for example be accessible by all customers, accessible by customers for a limited time, accessible a limited number of times, accessible by a predetermined population of customers, or combinations thereof, etc. A predetermined population of customers can include, but is not limited to, customers viewing a specified item, parking but not completing the purchase of the specified item, selecting the specified item of the selected merchant menu during a given time interval, customers arriving to the merchant during a given time interval or by a predetermined time, customers that select at least a purchasing threshold of items, or combinations thereof, etc.

In an example, the promotion or promotional item can be programmed by filtering customer preferences to identify populations of customers with common viewing or purchasing behavior. For example, an identified customer population can be cross referenced with merchants correlated to the filtered customer preference to identify preferred merchants. In an example, customer that have purchased or previously parked orders that include hamburgers can be cross referenced to merchants that provide hamburgers, cheeseburgers, fries, chicken sandwiches, fast food merchants, American cuisine restaurants, or combinations thereof, etc. The preferred merchants can be notified of a potential revenue generating customer population (e.g., customers that correlate to items offered by the merchant). The preferred merchants can, for example, be notified that they can choose to do a promotion on a specific item to access the identified customer population. In an example, the merchant can obtain access to the potential revenue generating customer population by, for example, purchasing a list of the customer population or participating in an auction for the list of the customer population.

In an example, the system for mobile ordering can permit the customer to customize an item. For example, the item can be altered by removing or adding features, such as condiments, ingredients, specific preparation/cooking instructions, substitute items, such as sides or beverages, or combinations thereof, etc. In an example, the customer can create their own menu item for the merchant's approval.

In an example, the system for mobile ordering may provide a reservation to the merchant for the customer. For example, the customer may make a reservation to dine at the merchant at a specific time. In an example, the customer may designate a time for the reservation and/or a time at which the parked order should be accessed by the merchant.

A parked order can include, an order waiting to be released from the database 232 for viewing and/or fulfillment by the merchant. Each parked order can include a unique identifier produced by database 232, at 220. The unique identifier can include a unique identifier as described herein.

In an example, the customer can remove items from the parked order as long as the parked order has not been provided to the merchant. For example, the customer may want to change from steak to chicken or remove an entrée. The customer may do so, for example, as long as the merchant has not accessed the parked order.

The merchant accesses the parked order on database 232, at 222. The merchant can, for example, access the parked order by providing the unique identifier to database 232. The unique identifier can, for example, be entered manually by a merchant representative (e.g., waiter, host, etc.). The unique identifier can, for example, be visually scanned, scanned with a barcode scanner, and/or combinations thereof, etc. In such examples, the merchant can provide the unique identifier without the use of a point of sale system (POS). Such examples can provide the benefit of, for example, less expense on equipment.

In an example, the system for mobile ordering can alert a merchant representative of the merchant that the parked order is ready for fulfillment. For example, the alert and/or unique identifier can be provided via near field communication, radio frequency identification, Bluetooth, wired or wireless communication connections, and/or combinations thereof, etc.

In an example, the merchant may be allowed to modify the parked order. For example, after the parked order is accessed by the merchant, the merchant may modify the order according to the customer's wishes, availability of the items, and/or combinations thereof, etc.

The system for mobile ordering, for example, may include communicating with the staff of the merchant. For example, the system may communicate directly with the kitchen staff of the merchant so that the retrieved parked order may be produced.

At 224, a final tally of the parked order is produced. For example, any modifications made by the merchant after accessing the parked order can be included in the final tally. The final tally can also include, for example, taxes, gratuity, discounts, group fee, and/or combinations thereof, etc.

At 226, the system for mobile ordering includes a payment decision. For example, at 226-1 the customer can authenticate and authorize payment of the final tally of the parked order. For example, the customer can permit payment with the stored payment information in the customer's profile. Payment information can include, but is not limited to, credit card information, debit card information, electronic check information, gift card information, frequent customer information, merchant credit information, and/or combinations thereof, etc.

In an example, the stored payment information, such as available funds, can be accessed by the merchant, in which a parked order has been placed. For example, after creation of the parked order, anytime up to placement of the parked order, a merchant, or the system for mobile ordering, can notify the customer the funds available in their profile or account do not satisfy the total charge for the parked order. After being notified of insufficient stored funds, the customer can choose to add funds, provide an additional payment means, modify the order, cancel the order, or combinations thereof, etc.

At 226-2, the system for mobile ordering can permit (e.g., force) customer authentication for payment. In an example, payment can be forced when a predetermined time has lapsed since fulfillment of the order. For example, the predetermined time can be provided by the customer in the customer's profile and/or the predetermined time can be provided by the merchant. That is, the term predetermined time designates that the time was set prior to when the order was parked. Such an example can provide the benefit of assuring the merchant that the parked order will be paid for if a customer inadvertently leaves prior to approving payment.

In an example, payment can be forced when the mobile device exceeds a threshold distance from the merchant. For example, the threshold distance can be provided by the customer in the customer's profile and/or the threshold distance can be provided by the merchant. Such an example can provide the benefit of assuring the merchant that the parked order will be paid for if a customer leaves prior to approving payment.

At 228, a receipt (e.g., proof of payment) is provided to the customer and/or merchant. The receipt can be provided to an email address of the customer, wherein the email address is stored with the customer profile. In another example, the receipt can be provided via text to the customer's mobile number. In an example, proof of payment can be provided to the customer via a mobile application for mobile ordering.

Further, while only a single device 215 or database 232 is illustrated, the term “device” and “database” shall also be taken to include any collection of machines that individually or jointly execute a set (or multiple sets) of instructions to perform any one or more of the methodologies discussed herein, such as cloud computing, “software as a service” (SaaS), other computer cluster configurations. For example, the functions of the machine (e.g., database 232) can be distributed across multiple other machines in a network.

FIG. 3 illustrates a block diagram 373 of an example of a computer-readable medium in communication with processing resources for mobile ordering according to the present disclosure. Computer-readable medium (CRM) 372 can be in communication with a computing device 374 having processor resources of more or fewer than 378-1, 378-2, . . . , 378-N, that can be in communication with, and/or receive a tangible non-transitory CRM 372 storing a set of computer-readable instructions (CRI) 376 executable by one or more of the processor resources (e.g., 378-1, 378-2, . . . , 378-N) for mobile ordering as described herein. The computing device 374 may include memory resources 380, and the processor resources 378-1, 378-2, . . . , 378-N may be coupled to the memory resources 380.

Processor resources can execute computer-readable instructions 376 for mobile ordering and are stored on an internal or external non-transitory CRM 372. A non-transitory CRM (e.g., 372), as used herein, can include volatile 384 and/or non-volatile memory 386. Volatile memory 384 can include memory that depends upon power to store information, such as various types of dynamic random access memory (DRAM), among others. Non-volatile memory 386 can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The non-transitory CRM 372 can be integral, or communicatively coupled, to a computing device, in either in a wired or wireless manner. For example, the non-transitory CRM can be an internal memory, a portable memory, a portable disk, or a memory located internal to another computing resource (e.g., enabling the computer-readable instructions 376 to be downloaded over the Internet).

The CRM 372 can be in communication with the processor resources (e.g., 378-1, 378-2, . . . , 378-N) via a communication path 382. The communication path 382 can be local or remote to a machine associated with the processor resources 378-1, 378-2, . . . , 378-N. Examples of a local communication path 382 can include an electronic bus internal to a machine such as a computer where the CRM 372 is one of volatile, non-volatile, fixed, and/or removable storage medium in communication with the processor resources (e.g., 378-1, 378-2, . . . , 378-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 382 can be such that the CRM 372 is remote from the processor resources (e.g., 378-1, 378-2, . . . , 378-N) such as in the example of a network connection between the CRM 372 and the processor resources (e.g., 378-1, 378-2, . . . , 378-N). That is, the communication path 382 can be a network connection. Examples of such a network connection can include a local area network (LAN), a wide area network (WAN), a personal area network (PAN), and the Internet, among others. In such examples, the CRM 372 may be associated with a first computing device and the processor resources (e.g., 378-1, 378-2, . . . , 378-N) may be associated with a second computing device.

Processor resources 378-1, 378-2, . . . , 378-N coupled to the memory 380 can provide a selected merchant of a list of merchants. A menu of the selected merchant can be displayed by processor resources 378-1, 378-2, . . . , 378-N. An order can be sent to the selected merchant. Processor resources 378-1, 378-2, . . . , 378-N coupled to the memory 380 can receive and display a unique identifier associated with the order. Payment for the order can be permitted. Processor resources 378-1, 378-2, . . . , 378-N coupled to the memory 380 can provide the system for mobile ordering as described herein.

The one or more processor resources 378-1, 378-2, . . . , 378-N can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., Application Program Interfaces (APIs).

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

The term “a number of” is meant to be understood as including at least one but not limited to one.

What is claimed:

1. A method for mobile ordering, comprising:
receiving an order for a selected merchant;
associating, by a computing device, a unique identifier for the order;
providing to the selected merchant, per a request from the selected merchant, the order associated with the unique identifier; and
finalizing the order.

2. The method of claim 1, wherein the method includes parking the order until the order is provided per the request from the selected merchant.

3. The method of claim 1, wherein the method includes:
storing a previous order from a customer; and
providing the stored previous order to the customer upon request of the customer.

4. The method of claim 1, wherein finalizing the order includes:
authorizing payment to the merchant for fulfilling the order;
storing information pertaining to the order; and
providing a merchant survey to the customer.

5. The method of claim 4, wherein the method includes:
storing a ranking associated with the merchant, wherein the ranking is provided by the merchant survey; and
providing the ranking associated with the merchant to the customer upon request of the customer.

6. The method of claim 5, wherein the method includes:
providing a list of merchants to the customer, wherein each merchant exceeds a threshold stored ranking; and
selecting the selected merchant from the list of merchants.

7. The method of claim 1, wherein the method includes providing merchant advertisements to the customer.

8. The method of claim 1, wherein the method includes:
storing merchant information, wherein the merchant information is modifiable by the merchant; and
providing the merchant modifiable information to the customer.

9. The method of claim 1, wherein the method includes:
storing a customer provided backup unique identifier; and
providing the order when the backup unique identifier is received.

10. A non-transitory computer-readable medium storing a set of instructions executable by a computer to cause the computer to:
provide a selected merchant of a list of merchants;
display a menu of the selected merchant;
send an order to the selected merchant;
receive a unique identifier associated with the order;
display the unique identifier; and
permit payment for the order.

11. The non-transitory computer-readable medium of claim 10, wherein the set of instructions executable by a computer cause the computer to display the list of merchants according to a customer constraint.

12. The non-transitory computer-readable medium of claim 11, wherein the set of instructions executable by a computer cause the computer to display the list of merchants according to the customer constraint that each merchant of the list of merchants is within a predetermined proximity of a mobile device.

13. The non-transitory computer-readable medium of claim 10, wherein the set of instructions executable by a computer cause the computer to provide a reservation to the merchant.

14. The non-transitory computer-readable medium of claim 10, wherein the set of instructions executable by a computer cause the computer to permit payment when a predetermined time has lapsed since fulfillment of the order.

15. The non-transitory computer-readable medium of claim 10, wherein the set of instructions executable by a computer cause the computer to permit payment when the mobile device exceeds a threshold distance from the merchant.

16. A computing system for mobile ordering, comprising:
a memory; and
a processor resource coupled to the memory, to:
provide to a customer a menu of a selected merchant;
park an order from the menu of the selected merchant;
associate a unique identifier with the parked order;
provide to the selected merchant information regarding a customer and the parked order in response to receiving the unique identifier; and
permit payment for fulfillment of the parked order.

17. The system of claim 16, wherein the processor resource is coupled to the memory to:
identify a customer population by at least one customer preference;
cross reference a list of merchants with the identified customer population to identify preferred merchants;
notify the preferred customers of the identified customer population.

18. The system of claim 16, wherein the processor resource is coupled to the memory to alert a merchant representative of the merchant that the parked order is ready for fulfillment.

19. The system of claim 16, wherein the processor resource is coupled to the memory to associate customer profile information with merchant profile information.

20. The system of claim 16, wherein the processor resource is coupled to the memory to:
determine a promotional item from a number of parked orders or fulfilled orders;
designate a menu item of the selected merchant as the promotional item; and
provide to the customer the menu of the selected merchant, including the promotional item.
